(19) United States
(12) Patent Application Publication
(10) Pub. No.: US 2008/0272192 A1
(43) Pub. Date: Nov. 6, 2008

(54) ENERGY EXCHANGE EQUIPMENT

(76) Inventors: Chun-Chu LIN, Taipei City (TW); Yo-Fu Fang, Taipei City (TW); Jen-Chih Liu, Taipei City (TW); Huan-Tsung Lee, Taipei City (TW)

Correspondence Address: SINORICA, LLC, 528 FALLSGROVE DRIVE, ROCKVILLE, MD, 20850, US

(21) Appl. No.: 11/863,206

(22) Filed: Sep. 27, 2007

(30) Foreign Application Priority Data
May 4, 2007 (TW) 096207115

(51) Int. Cl. G06F 7/06

(52) U.S. Cl. 235/381

(57) ABSTRACT

Energy exchange equipment is disclosed, which can sell batteries that have been recharged already. A user can buy a new battery from the energy exchange equipment by using a smart card. If a user has an old battery, he can put this old battery in an energy tank on the energy exchange equipment and then extract a new battery. If a user has no old battery, he can directly extract a new battery. The energy exchange equipment then deducts a corresponding amount of money in the smart card based on the electric capacity difference between the extracted new battery and the old battery.

### BACKGROUND OF THE INVENTION

1. Field of the invention

The present invention relates to an energy exchange equipment and, more particularly, to an energy exchange equipment utilizing smart cards for deduction of money.

2. Description of Related art

Batteries can roughly be divided into rechargeable batteries and non-rechargeable batteries. Non-rechargeable batteries such as primary cells, as implied by the name, are batteries that can only be used once, and cannot be recharged to replenish the dissipated chemical energy. Common non-rechargeable batteries include dry batteries, mercury batteries, alkaline batteries, and so on.

Rechargeable batteries such as secondary batteries and fuel cells are batteries that can be repetitively recycled. Through the recharging process, active materials in the rechargeable batteries can be restored to the original state so as to provide electricity again. Rechargeable batteries include lead acid batteries, nickel cadmium batteries, nickel hydrogen batteries, secondary lithium batteries, lithium ion batteries, polymer lithium batteries, and so on.

Fuel cells, also called continuous batteries, are characterized in that active materials do not exist at the anode and cathode, but are supplied from an external system. As long as active materials can be supplied continually, the battery can provide sustainable electricity. At the anode, the active material is air or oxygen. At the cathode, the active material is hydrogen or gas. This kind of batteries includes hydrogen-oxygen fuel cells, and is primarily used in generators and electric vehicles or as backup energy.

The drawback of non-rechargeable batteries is that they can only be used once, and is difficult to recycle. In Taiwan, approximately ten thousands tons of dry batteries are used, but only less than 10% of them are recycled. Dry batteries contain harmful materials like mercury, cadmium, and lead. If dry batteries are buried or burned, these harmful materials will exist in the water source and soil for a long time, causing much danger to the ecologic environment and human health.

Therefore, rechargeable batteries are better for environmental protection as compared to non-rechargeable batteries. There are many rechargeable batteries belonging to the secondary batteries in the market. A user first purchases a rechargeable battery and then recharges it at home or anywhere that provides a battery socket. The recharging fee is collected by the power company every two months.

However, the battery socket does not everywhere. For instance, if a user is at a beach and a rechargeable battery has run out and it is very urgent to recharge the battery, the drawback of rechargeable batteries emerges.

Accordingly, the present invention aims to propose an energy exchange equipment to solve the above problem of rechargeable batteries.

### SUMMARY OF THE INVENTION

A primary object of the present invention is to provide energy exchange equipment, which adopts a fee collecting method that bases on the usable battery capacity and is more advantageous to users.

Another object of the present invention is to provide energy exchange equipment, which is an energy exchange station for selling batteries that has been recharged already.

Yet another embodiment of the present invention is to provide energy exchange equipment, which utilizes smart cards that can store value and deduct money as tools for transaction.

To achieve the above objects, the present invention provides energy exchange equipment, in which a smart card in inserted by a user and the remaining sum of money of the smart card is displayed. The user then inserts a first energy box into the energy exchange equipment and extracts a second energy box from the energy exchange equipment. Finally, a corresponding amount of money in the smart card is deducted by the energy exchange equipment based on the electric capacity difference between the first energy box and the second energy box.

### BRIEF DESCRIPTION OF THE DRAWINGS

The various objects and advantages of the present invention will be more readily understood from the following detailed description when read in conjunction with the appended drawing, in which:

FIG. 1 is a diagram of an energy exchange equipment of the present invention;

FIG. 2 is a diagram of an energy exchange equipment according to another embodiment of the present invention; and

FIG. 3 is a diagram showing the flowchart of implementation of the present invention.

### DETAILED DESCRIPTION OF THE PREFERRED EMBODIMENTS

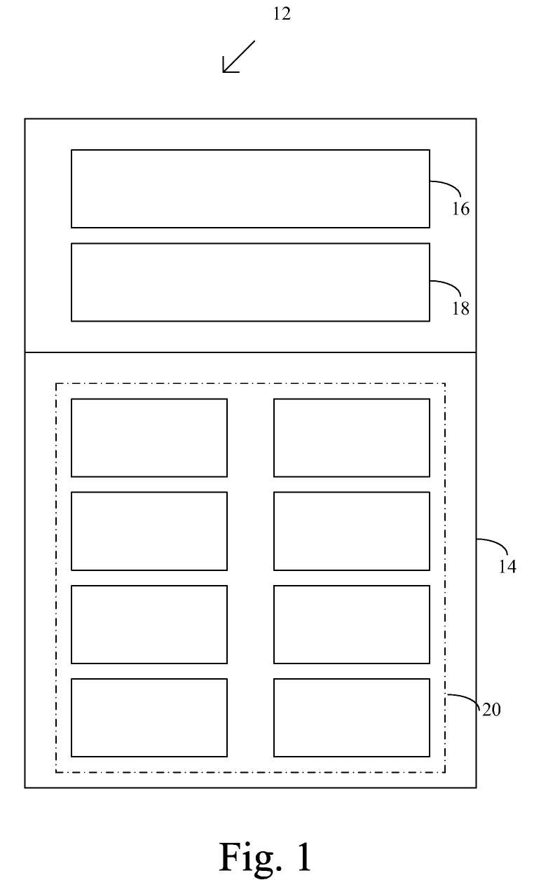

As shown in FIG. 1, the present invention provides an energy exchange equipment, which can be installed at any place like a beach, a roadside, a scene, a mountain, a port, and so on. The energy exchange equipment can connect a power cord for charging a secondary battery, or can utilize a device built therein to replenish the capacity of a fuel cell without connecting a power cord. These are all embraced within the scope of the invention.

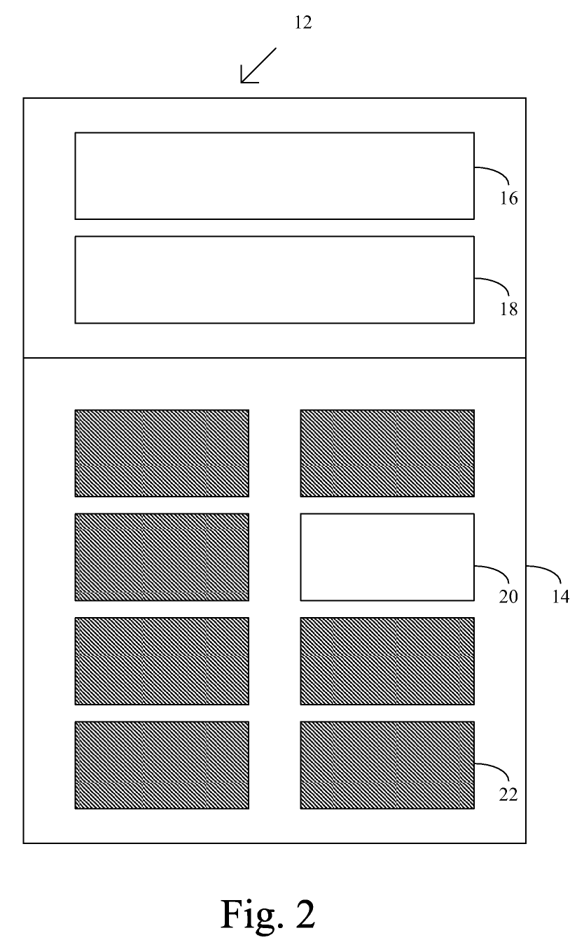

The present invention provides energy exchange equipment 12, which comprises a main body 14. The main body 14 includes a screen 16, a smart card device 18, and a set of energy tanks 20. The number of the energy tanks 20 can be expanded. In FIG. 1, there are eight energy tanks 20. Each of the energy tanks 20 can be matched with an extraction energy box 22. The extraction energy box 22 can be inserted into the energy tank 20, as shown in FIG. 2. In this embodiment, the extraction energy box 22 is a rechargeable battery such as a secondary battery (e.g., a lithium ion battery or a polymer lithium battery) or a fuel cell. The rechargeable battery is used in cars, motorcycles, bicycles, or any electronic products driven by batteries.

The smart card device 18 is built in the main body 14. When a user inserted a smart card in the main body 14, the smart card device 18 can read the smart card. The user can utilize a control module and the screen 16 to store value, insert an energy box, extract an energy box, or deduct money according to the indications shown on the screen 16. The smart card can be an IC card, a credit card, or plastic money.

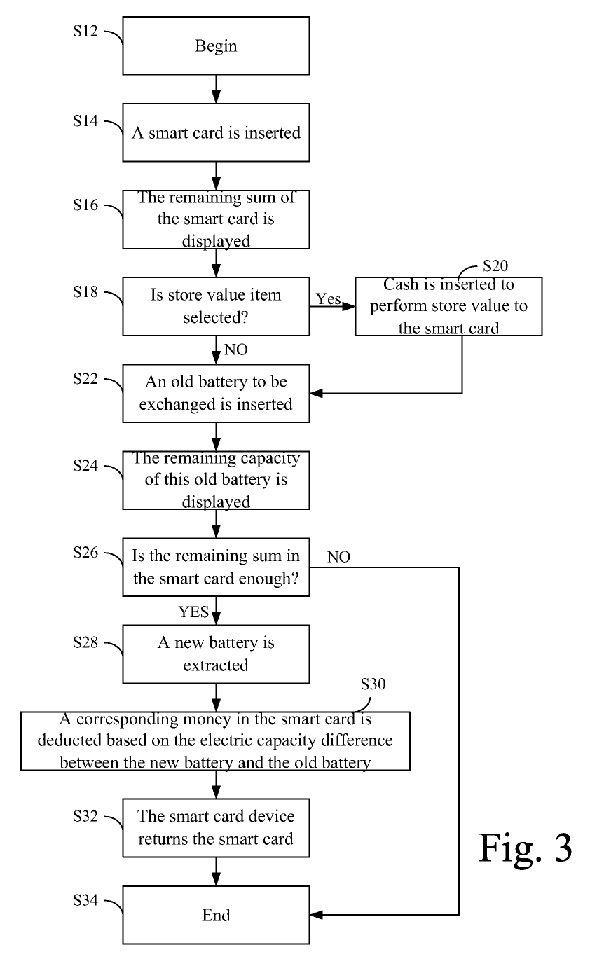

FIG. 3 is a diagram showing the flowchart of implementation of the present invention. First, a user starts energy exchange (Step S12) and inserts a smart card into the smart card device 18 (Step S14). The energy exchange equipment 12 then displays the information in the smart card on the screen 16 (Step S16). The information contains the remaining sum in the smart card.

Next, if the remaining sum in the smart card is not enough, the user can utilize the control module on the energy exchange equipment 12 to select either a value-storing step S20 or another step S22 (Step S18).

If the user selects the Step S20, he first inserts cash into the smart card device 20 to store value and then proceeds to the Step S22.

Subsequently, the user inserts an old battery to be exchanged (Step S22), and the remaining electric capacity of this old battery is displayed (Step S24).

The remaining capacity of an old battery depends on many factors. For example, the maximum capacity of a secondary battery will decrease after several times of charging and discharging. The remaining capacity of an old battery not in use for a long time will also decrease. Moreover, an old battery not in use for a long time is more subject to damage than an old battery that has been charged and discharged several times. A battery makes use of chemical materials to convert chemical energy to electric energy. These chemical materials should always keep their activity so as not to become inactive or deteriorated. When the activity of the original chemical materials is totally depleted or near depletion, new chemical actions can hardly occur, and the battery capacity therefore drops. This battery is aged. Even when an old battery is aged, it still contains a certain capacity that just cannot be outputted. In other words, the capacity in an old battery that cannot be outputted is considerable. It should be noted that the old battery in the steps S22 and S24 is purchased by the user from the energy exchange equipments 12 installed everywhere, convenience stores, retail stores, or distributors. If the user has no old battery, the steps S22 and S24 can be saved to directly proceed to Step S26.

In Step S26, the user utilizes the control module to select an extraction energy box 22 located in a certain energy tank 20, and the energy exchange equipment 12 determines whether the remaining sum in the smart card is enough. The mathematical expression of determination is: (the remaining sum in the smart card)>(the degree of electricity of the second energy box−the degree of electricity of the first energy box)×(price per degree of electricity). In other words, when the energy exchange equipment 12 cannot deduct the corresponding money in the smart card, Step S34 is performed to stop energy exchange.

When the energy exchange equipment 12 determines that the remaining sum in the smart card is larger than the difference between the degree of electricity of the second energy box and the first energy box multiplied by the price per degree of electricity, the user extracts a new battery after the screen 16 indicates that he can extract a new battery (Step S28), and the smart card device 18 deducts a corresponding money in the smart card based on the electric capacity difference between the extracted new battery and the old battery. (Step S30).

The present invention has the following advantage. When a user purchases a new battery, this battery contains electricity that can be outputted and electricity that cannot be outputted due to aging or other factors. The money deduction mechanism proposed in the present invention excludes the electricity that cannot be outputted to save unnecessary expense of user, thereby substantially saving user's money.

After deduction of money, the smart card device 18 returns the smart card and indicates that the user can retrieve the smart card on the screen 16 (Step S32), and the energy exchange is finished (Step S34).

Furthermore, a network card and related network equipments can be provided inside the energy exchange equipment 12 so that an energy control center can monitor and control the energy exchange equipment 12 via the Internet. The energy exchange equipment 12 proposed in the present invention can be installed everywhere so that users can conveniently purchase batteries. Different from the conventional mode of battery purchase, the present invention adopts a fee collecting method that bases on the usable battery capacity and is more advantageous to users.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An energy exchange equipment comprising:
a main body having a screen and a set of energy tanks;
a plurality of extraction energy boxes each matched with one of said energy tanks;
a smart card device built in said main body and capable of reading a smart card inserted into said main body; and
a control module for deducting a corresponding amount of money from remaining sum of a smart card according to actual degree of electricity of an extracted one of said energy boxes when said smart card is inserted into said main body.

2. The energy exchange equipment as claimed in claim 1, wherein said smart card is an IC card.

3. The energy exchange equipment as claimed in claim 1, wherein said smart card device has function of storing value.

4. The energy exchange equipment as claimed in claim 1, wherein said extraction energy box is a rechargeable battery.

5. The energy exchange equipment as claimed in claim 4, wherein said rechargeable battery is a lithium ion battery, polymer lithium battery or a fuel cell.

6. The energy exchange equipment as claimed in claim 1, wherein a network card is built in said main body.

7. The energy exchange equipment as claimed in claim 1, wherein an energy control center monitors and controls said energy exchange equipment by means of said network card via the Internet.

8. The energy exchange equipment as claimed in claim 4, wherein said rechargeable battery is used by cars, motorcycles, bicycles, or any electronic products driven by batteries.

9. The energy exchange equipment as claimed in claim 1, wherein said energy box is purchased from said energy exchange equipment, convenience stores, retail stores, or distributors.
